(19) United States
(12) Patent Application Publication
(10) Pub. No.: US 2008/0023590 A1
(43) Pub. Date: Jan. 31, 2008

(54) Boundary layer pumped propulsion system for vehicles

(76) Inventors: Gerald L. Merrill, Tempe, AZ (US); Shahid Siddiqi, Poquoson, VA (US)

Correspondence Address: RONALD L. HOFER, 122 LINDBERGH LANE, MOORESVILLE, NC, 28117, US

(21) Appl. No.: 11/495,176

(22) Filed: Jul. 28, 2006

(51) Int. Cl. B64C 21/06

(52) U.S. Cl. 244/208

(57) ABSTRACT

An aerodynamic body comprising at least one power plant inlet positioned in proximity to, and in fluid communication with, a boundary layer transition location associated with a boundary layer fluid flow over a surface of said aerodynamic body, the one or more power plant inlets operable for extracting at least a portion of said boundary layer fluid flow, thereby reducing drag on said aerodynamic body.

### BACKGROUND OF THE INVENTION

The present invention relates to a vehicle design with power plant air inlets configured to provide a vehicle with reduced parasite drag. The present invention is particularly suitable for use in aircraft.

Researchers have long sought to improve aircraft performance and/or efficiency by reducing drag, and in particular, skin friction drag. It is known that laminar flow boundary layers have less skin friction drag than turbulent flow boundary layers and, hence, one approach to drag reduction has been to increase the extent of laminar flow over the aircraft surfaces. Full length laminar flow or almost full length laminar flow can be achieved using boundary layer control suction systems but in the past such systems required thousands of laser drilled holes or closely spaced thin slots in the aircraft skin. The manufacturing complexity and cost associated with this approach has made it impractical for most aircraft uses.

The majesty of laminar flow and the reason it has driven so many researchers is that the skin friction drag of a 100% laminar flow airplane is eight times lower than that of an equivalent 100% turbulent flow airplane at general aviation Reynolds and Mach numbers. Such an ideal fully laminar flow airplane would therefore have twice the cruise speed of its equivalent fully turbulent flow airplane on the same installed power. Despite this, the lofty summit of 100% laminar flow remains unconquered in practical flight applications. The quest, however, captivated some of the most talented aeronautical engineers from the 1930s to the 1990s.

Thus, there remains a need for a system and method which provides a full length laminar flow or near full length laminar flow aircraft which system and method do not require complex manufacturing techniques and are economically practical. Such a system and method are provided by the present invention which uses power plant inlets to completely ingest the airplanes boundary layer as provided in more detail below.

Further understanding of the present invention will be had from the following disclosure and claims taken in combination with the accompanying drawings wherein the following acronyms are used:
“BL” for “Boundary Layer”
“BLC” for “Boundary Layer Control”
“BLPP” for “Boundary Layer Pumped Propulsion”
“CFD” for “Computational Fluid Dynamics”
“GA” for “General Aviation”
“NLF” for “Natural Laminar Flow”
“NS” for “Navier Stokes Equation”
“psf” for “pounds per square foot”
“q” for “dynamic pressure”
“Re” for “Reynolds Number”
“SBIR” for “Small Business Innovative Research”
“UWAL” for “Univ. of Washington Aeronautical Test Lab”.

### SUMMARY OF THE INVENTION

The present aircraft design innovation is a Boundary Layer Pumped Propulsion (BLPP) aircraft configuration that employs engine inlets synergistically located near BL transitions locations to provide dramatic airplane parasite drag reduction. The BLPP technique extracts the aircraft boundary layer through distributed inlets designed to ingest the BL air prior to its transition to turbulent flow and duct the BL efficiently to a prime mover such as a turbofan engine(s) buried inside the rear of the fuselage. There is also a gain in propulsive efficiency by employing BLPP because the engine(s) use energy more efficiently when they have to accelerate BL ingested air to the propulsor(s) exit velocity compared to the conventional case where they ingest a stream of air at flight speed. The fully integrated BLPP engine(s) provide the sole propulsive thrust for the aircraft. The BLPP aircraft design achieves these gains by carefully designing the contours of both the external and internal surfaces to ensure aerodynamic efficiency over the entire aircraft flow field. Thus the BLPP configuration offers aircraft decisive performance advantages in speed, range and endurance, and/or payload capability.

### BRIEF DESCRIPTION OF THE FIGURES

FIG. 1 is a side elevational view showing an aircraft fuselage of the present invention;

FIG. 2 is a photograph of the aircraft fuselage shown in FIG. 1;

FIGS. 3-6 are photographs of the aircraft fuselage of FIG. 1 showing the NLF flow extent on the fuselage made visible through flow visualization;

FIG. 7 is a photograph of the aircraft fuselage showing the fore body and inlet NLF for a q=80 test run;

FIGS. 8-11 are photographs of the aircraft fuselage showing the flow visualization patterns seen during a forced turbulence flow experiment; and

FIG. 12 is a graph showing the drag of rotationally symmetric bodies.

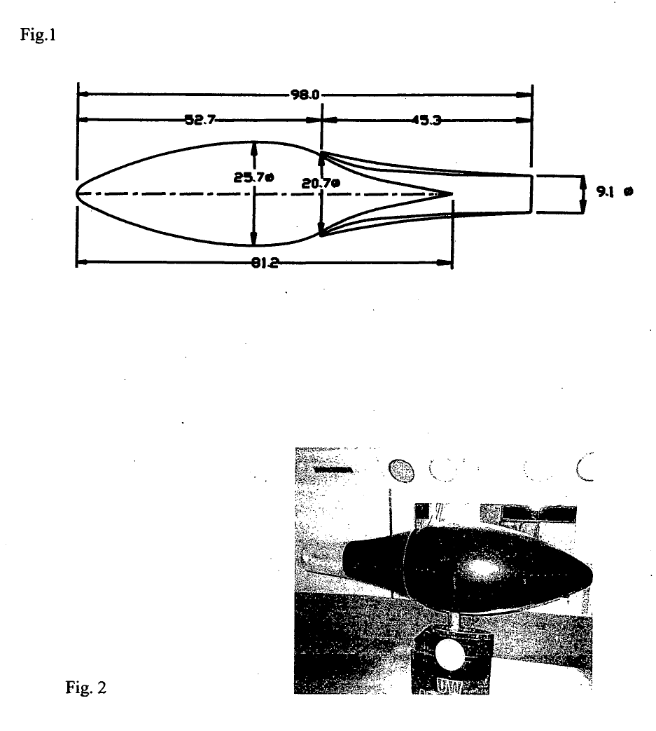

### DETAILED DESCRIPTION OF THE INVENTION

The present invention was developed under NASA's SBIR program to provide a decisive airplane drag reduction innovation. Wind tunnel tests clearly showed that over 90% of the fuselage flow was laminarized by extracting the built up fuselage boundary layer through the conformal BLPP duct that is placed around the fuselage as is shown in FIG. 1. These wind tunnel tests verified the BLPP technique qualitatively by employing flow visualization and quantitatively with force balance measurements in the Reynolds number (Re) range of 3-15 Million.

In addition, the wind tunnel balance measurements have shown approximately 50% reduction in the parasite drag compared to the baseline test body, which was an axis symmetric shape designed using 3D Navier Stokes CFD to achieve 65% extent of NLF.

The critical barrier today preventing the use of almost full-length laminar flow on airplanes is the manufacturing complexity imposed by boundary layer control (BLC) suction systems that require thousands of laser drilled holes or closely spaced thin slots. The BLPP technique completely avoids this fabrication complexity and thereby its cost penalty by using engine inlets to completely ingest the airplane's boundary layer.

The BLPP technique is an advance in the aerodynamic art in that it provides nearly 100% NLF on an axis-symmetric body without thousands of suction holes. The BLPP technique offers great cost advantages over the BLC suction approach.

The BLPP technique offers immediate practical applications for 3 classes of airplanes:
1. UAV's with fuselage lengths up to 10 ft for sea Level cruise speeds of up to 200 mph;
2. The new Light Sport Aircraft class (piton engine BLPP is possible) with fuselage lengths of approximately 15 ft and a maximum speed of 120 knots; and
3. General Aviation aircraft up to the business jet sized airplanes.
   The above classes of airplanes fall within the 3-10 Million Re range tested by the present inventors. The value to this emerging class is immense, beyond the obvious lower power requirement are 2 distinct advantages:
a. The BLPP duct buried engine & propeller/impulsor reduces risks to humans; and
b. The BLPP duct reduces propeller/impulsor noise both for the community and the cabin.

The BLPP technique can also apply to larger GA airplanes. Airplanes with fuselage lengths of approximately 20 ft would have a Re of 40 Million at Sea Level and 20 Million in cruise at 25,000 ft if cruising at 200 knots. Since these lie outside the tested range (the limit was tunnel speed and blockage) further wind tunnel tests and or flight experiments should be carried out to determine the Re applicability range. However, the inventors' CFD simulations suggest BLPP applies for these Re ranges. Immediate applicability to a blended wing-body GA airplane configuration (200 knot cruise and average length of 12 ft) therefore is strongly suggested.

Wind tunnel tests to extend the applicability range to higher Re should be a natural follow-on because preliminary CFD evaluations show extensibility. These UWAL tests extended transition Re beyond 15 Million, which was the tunnel limit and model size limit.

The BLPP drag reduction technique is therefore an integrated aircraft configuration and propulsion system design that combines significant aircraft drag reduction with increased propulsion system efficiency. The preferred BLPP airplane application is to first target the fuselage and then design wings with integral BLPP inlets to achieve very high fraction of airframe NLF thereby achieving greatly reduced parasite drag.

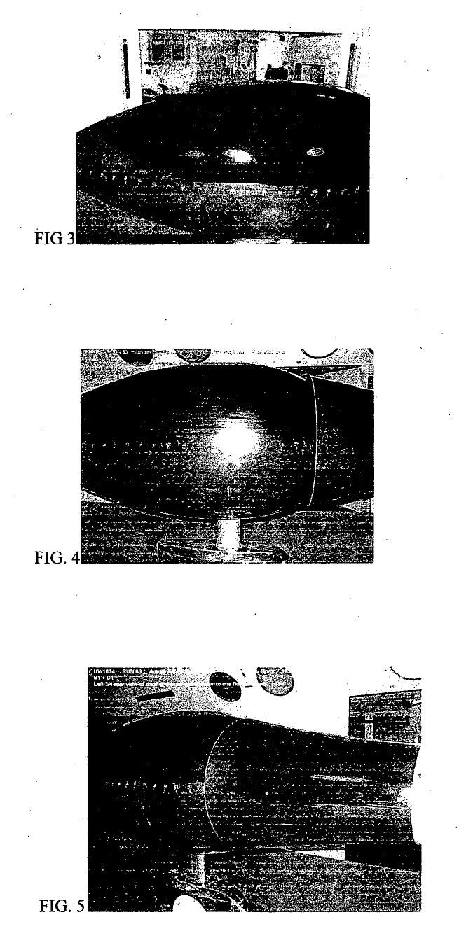

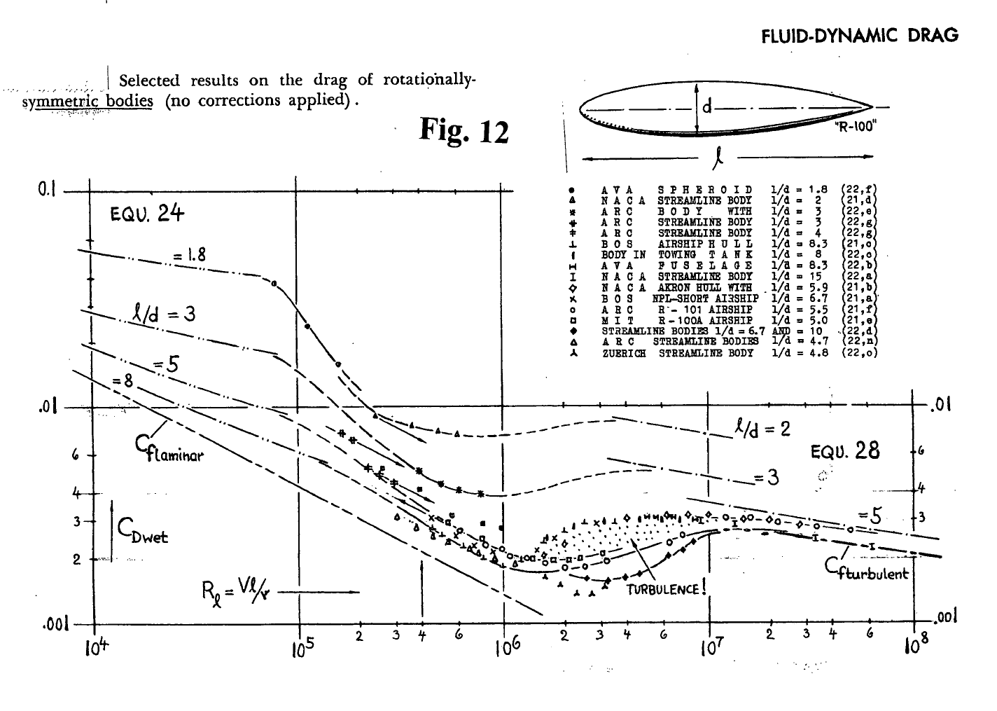

Referring to FIGS. 3-6, shown are pictures of wind tunnel tests showing laminar flow over almost the entire test fuselage of the present invention. FIG. 12 shows a plot of the measure drag coefficient plotted on a historical plot taken from a standard reference, Fluid Dynamic Drag by Sighard F. Hoerner, 1965.

The flow visualizations of FIGS. 3-6 were done using kerosene and its evaporation pattern was observed to demarcate regions of LF from TURBULENT FLOW. The upper side of the fuselage was “painted with kerosene and so appears black while the unpainted lower fuselage shows its grayish composite color. After the kerosene “painting” the WT was run up to a q=60 and the flow pattern was photographed once steady state was reached. The NLF shows as smooth kerosene flow but if the flow were to transition to turbulence the kerosene would evaporate and thus show the region of TURBULENT FLOW.

The set of 4 photographs in FIGS. 3-5 show the NLF flow extent on the BLPP fuselage made visible through flow visualization. FIG. 6 shows a TH wedge deliberately created by placing a small surface irregularity or discontinuity at about 50% of the fore body length. A small turbulent wedge developed behind this discontinuity as is evident from the grey color of the evaporated kerosene region surrounded by the black colored LF region surrounding the discontinuity.

In FIGS. 3, 4 and 5 the fore body clearly shows NLF going into the BLPP inlet and despite the reflections in this photo it is clear that the flow after the inlet is also laminar. FIGS. 3, 4 and 5 show that a new BL has started on the aft body external surface after the inlet and the designed contour has a favorable pressure gradient that maintains a gentle flow acceleration that maintains NLF. Since flow visualization is not as visible on the aluminum tail cone as it is on the composite material surface of the aft body it was not determined whether the flow stayed laminar all the way to the aft body tail cone exit.

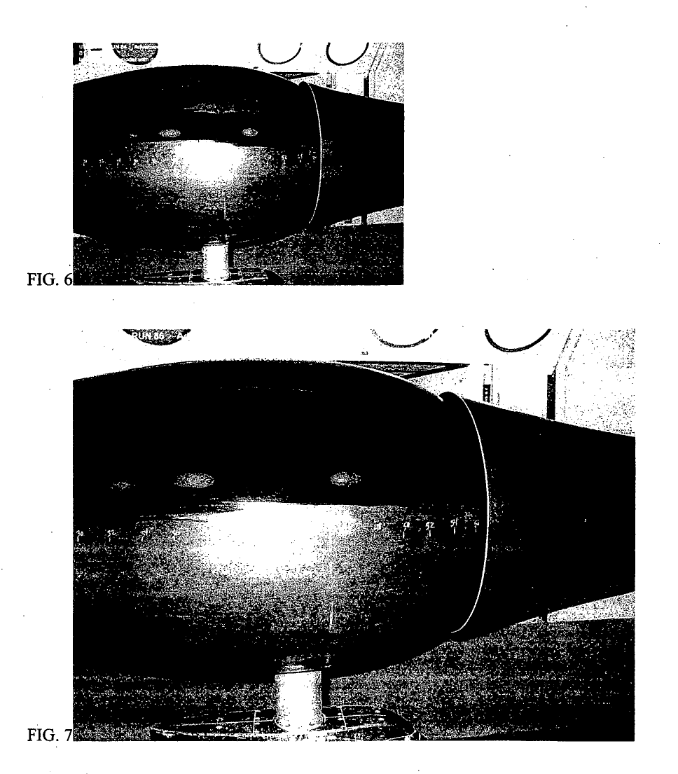

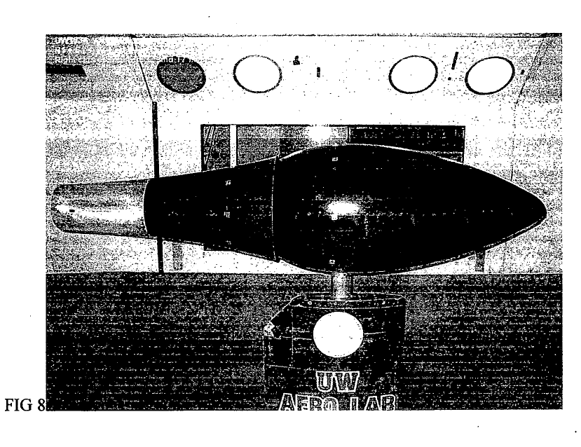

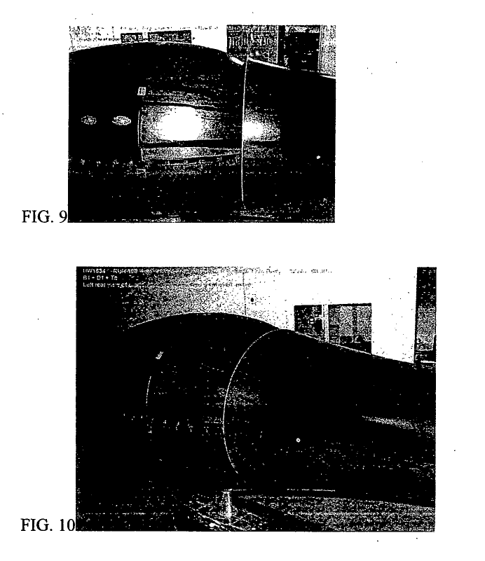

FIG. 7 shows the fore body and inlet NLF and was included to show the flow visualization result of a q=80 run.

Thus, the above Figures qualitatively verify that for Re=8 Million the BLPP fuselage achieved NLLF over 85% or more of its length. This represents almost 90% of the wetted area of the BLPP fuselage and hence provides a significant drag reduction compared to a non BLPP fuselage.

Of course, the practical application of BLPP in airplane design requires the robustness or turbulence tolerance capability of the BLPP technique. Therefore, a series of forced turbulence flow experiments at q=60 were conducted. Trip wires were placed at the fore body max thickness and some distance behind the BLPP inlet on the aft body. The wires diameter is on the order of ½ or so local BL thickness so will force turbulence. The results of these experiments are shown in FIGS. 8-10 which show flow visualization patterns seen for q=60.

FIGS. 9 and 10 show TURBULENT FLOW after the fore body trip, this TF is then ingested by the BLPP inlet. The key observations made from FIGS. 9 and 10 are that the flow after the BLPP inlet remains laminar despite the TF entering the inlet. This clearly shows that the BLPP technique is robust because the new BL starting from the BLPP inlet is unaffected by the fore body turbulence.

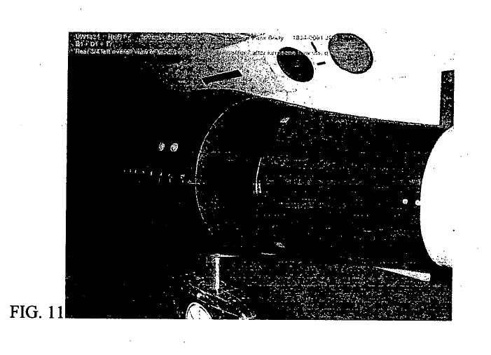

Then the q=60 case was re-run with the 2^{nd} trip wire placed on the aft body behind the BLPP inlet at 1=65%. The flow visualization pattern is shown in FIG. 11. Clearly the trip wire forces turbulence and the TURBULENT FLOW extends to the tail cone but the flow from the BLPP inlet to the trip wire remains laminar. FIG. 11 verifies the turbulence tolerance of the BLPP technique.

What is claimed is:

1. An aerodynamic body comprising at least one power plant inlet positioned in proximity to, and in fluid communication with, a boundary layer transition location associated with a boundary layer fluid flow over a surface of said aerodynamic body, the one or more power plant inlets operable for extracting at least a portion of said boundary layer fluid flow, thereby reducing drag on said aerodynamic body.
